(19) United States
(12) Patent Application Publication
(10) Pub. No.: US 2017/0211371 A1
(43) Pub. Date: Jul. 27, 2017

(54) FRACTURE MONITORING

(71) Applicant: SCHLUMBERGER TECHNOLOGY CORPORATION, Sugar Land, TX (US)

(72) Inventors: Dominic Joseph Brady, Dhahran (SA); Mohammed Badri, Al-Khobar (SA)

(21) Appl. No.: 15/003,110

(22) Filed: Jan. 21, 2016

(51) Int. Cl. E21B 47/00; E21B 47/12; G01N 27/416; G01L 1/16; H01M 6/32; E21B 43/267; G01V 3/18

(52) U.S. Cl. CPC E21B 47/00; E21B 43/267; E21B 47/12; G01V 3/18; G01L 1/16; H01M 6/32; G01N 27/416

(57) ABSTRACT

Fracture monitoring is provided. In one possible implementation, a smart proppant bead includes electronic functionality, a transmitter, a sensor and a power source. In another possible implementation, a smart proppant bead includes electronic functionality, a transmitter, a receiver, a sensor and a power source. In yet another possible implementation, a smart proppant bead includes a computer-readable tangible medium with instructions directing a processor to receive an activation signal and access identification information associated with the smart proppant bead. Additional instructions direct a transmitter on the smart proppant bead to transmit the identification information associated with the smart proppant bead.

### BACKGROUND

Hydraulic fracturing can be employed to enhance the productivity of wellbores in hydrocarbon bearing formations, including in so-called “tight” formations where reservoir permeability is otherwise too low for economic production.

Under the process of hydraulic fracturing, a number of different stages, or ramps, can be pumped into a formation. The first ramp can be used to initiate and grow a small fracture, called a “calibration fracture” in the formation, which can be used to determine the instantaneous shut-in pressure (ISIP) in the formation at the point of the calibration fracture. The calibration fracture can also be used to create a temperature log to help determine locations in the fracture where fracture fluid can be accepted.

After temperature profiles have been acquired, the main fracturing ramp can occur. This can involve re-pressurizing the wellbore with non-viscous “slickwater” type fluids at high rates (including, for example, up to 60 bbl/min) to force open rock in the formation despite existing in-situ stresses, and generate narrow fractures with complex networks. During this process proppant can be tailed in at concentrations ranging from, for example, 0.5 PPA to 10 PPA. Proppant (such as sand, sintered bauxite, etc.) can be used to pack the fracture and maintain conductive fluid flow channels after the fracturing pressure is removed and the in-situ stresses attempt to re-close the fracture.

### SUMMARY

Fracture monitoring is provided. In one possible implementation, a smart proppant bead includes electronic functionality, a transmitter, a sensor and a power source.

In another possible implementation, a smart proppant bead includes electronic functionality, a transmitter, a receiver, a sensor and a power source.

In yet another possible implementation, a smart proppant bead includes a computer-readable tangible medium with instructions directing a processor to receive an activation signal and access identification information associated with the smart proppant bead. Additional instructions direct a transmitter on the smart proppant bead to transmit the identification information associated with the smart proppant bead.

This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates an example wellbore in which embodiments of fracture monitoring can be employed;

FIG. 2 illustrates another example wellbore in which embodiments of fracture monitoring can be employed;

FIG. 3 illustrates example smart proppant beads in accordance with implementations of fracture monitoring;

FIG. 4 illustrates an example proppant pack in accordance with implementations of fracture monitoring;

FIG. 5 illustrates an example method associated with embodiments of fracture monitoring; and

FIG. 6 illustrates an example computing device that can be used in accordance with various implementations of fracture monitoring.

### DETAILED DESCRIPTION

In the following description, numerous details are set forth to provide an understanding of some embodiments of the present disclosure. However, it will be understood by those of ordinary skill in the art that the system and/or methodology may be practiced without these details and that numerous variations or modifications from the described embodiments may be possible.

Additionally, some examples discussed herein involve technologies associated with the oilfield services industry. It will be understood however that the techniques of fracture monitoring may also be useful in a wide range of other industries outside of the oilfield services sector, including for example, water services, mining, geothermal power systems and geological surveying, etc.

As described herein, various techniques and technologies associated with fracture monitoring can be used for a variety of purposes, including providing data to assist engineers and others interpret characteristics such as fracture geometries, fluid flow, pressure, etc., inside fractures created by hydraulic fracturing operations. In one possible implementation, the data can be collected using smart proppant beads placed in the fractures during the hydraulic fracturing operations.

### Example Wellbore(s)

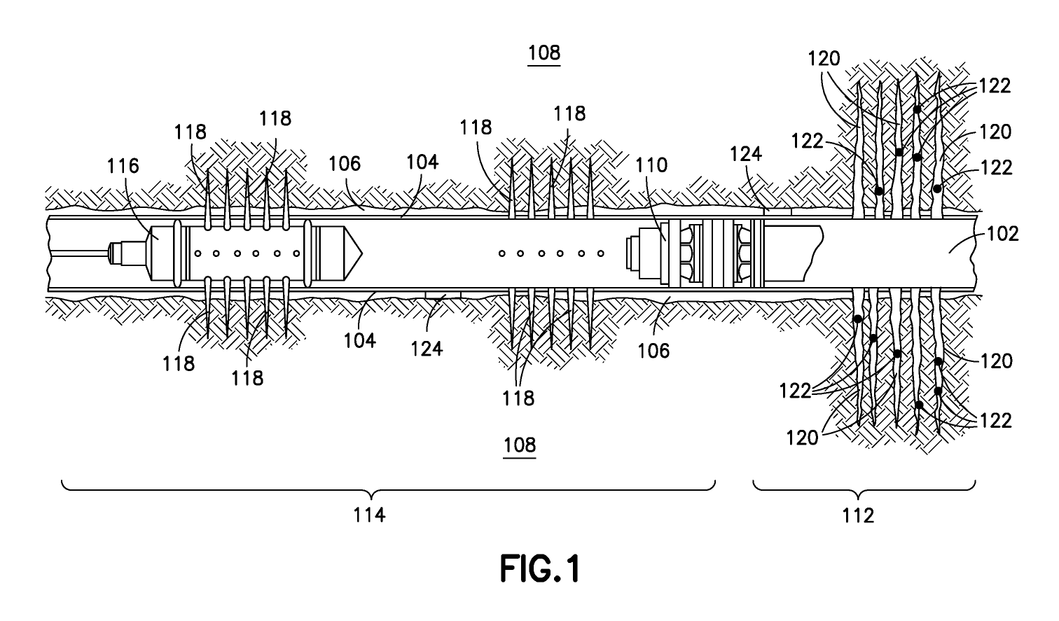

FIG. 1 illustrates an example wellbore 102 in which embodiments of fracture monitoring can be employed. Wellbore 102 can be onshore or offshore and can be formed in any manner known in the art. Similarly, wellbore 102 can be subjected to a variety of different fracturing operations.

For example, in FIG. 1 a plug and perforation operation in wellbore 102 is illustrated. As shown, a casing 104 can be fixed in place inside wellbore 102 using cement 106. In one possible implementation, casing 104 can hydraulically isolate wellbore 102 from a formation 108 surrounding wellbore 102. In one possible aspect, a plug 110, such as a packer, etc., can be set inside casing 104 hydraulically isolating a first section 112 of wellbore 102 from a second section 114 of wellbore 102.

A tool 116, such as a wireline tool, can be run into wellbore 102 to explosively perforate casing 104 and form perforations 118 into formation 108, providing hydraulic connectivity between wellbore 102 and formation 108. Tool 116 can then be removed and fracturing fluid and proppant can be introduced under pressure into casing 104, expanding perforations 118 into fractures 120 in formation 108. In one possible embodiment, smart proppant beads 122 configured to receive (and/or measure) and transmit a variety of information, can be included in the fracturing fluid in one or more ramps, and thus become wedged into multiple locations in fractures 120.

In one possible implementation, one or more loggers 124 such as sensors, etc., capable of receiving a variety of information (including, for example, electromagnetic signals, acoustic signals, electric signals, etc.) can be placed behind casing 104, i.e. between formation 108 and casing 104, at various points along a length of wellbore 102. Loggers 124 can include any sensing technology known in the art, such as, for example, antennas, coils, hydrophones, devices configured to measure voltages, etc.

In one possible aspect, loggers 124 can be cemented in-place with cement 106 such that signals from smart proppant beads 122 in fractures 120 can be received before they propagate through casing 102. Alternately, or additionally, in another possible implementation, loggers 124 can be deployed inside wellbore 102 via equipment in wellbore 102, such as, for example, an intervention tool, after hydraulic fracturing of wellbore 102 has been completed. In one possible aspect, data signals transmitted from smart proppant beads 122 using, for example, electromagnetic signals, acoustic signals, electric signals, etc., can continue being transmitted in fractures 120 until an end of the fracturing operation such that one or more trip of the equipment with loggers 124 thereon can be made into wellbore 102 to collect data transmitted by smart proppant beads 122.

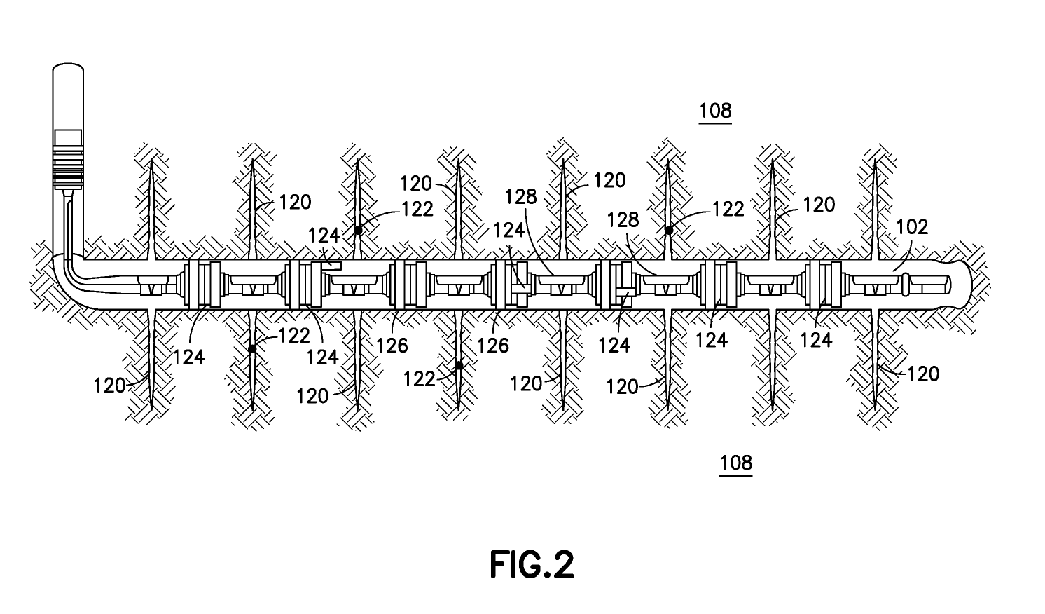

FIG. 2 illustrates example wellbore 102 undergoing sliding sleeve hydraulic fracturing in accordance with embodiments of fracture monitoring. In one possible implementation, sliding sleeve fracturing operations can utilize an installed completion string 126 comprising multiple isolation packers 128 and fracture sleeves 130, as well as production tubing, inside wellbore 102. In one possible aspect, wellbore 102 can be an open-hole wellbore. In another possible aspect, completion string 126 can be permanently installed in wellbore 102.

In operation, mechanically actuated valves in completion string 126 can be utilized to expose areas of formation 108 to fracturing fluids under pressure flowing through completion string 126. These fracturing fluids, which in some ramps can include proppant, can develop fractures 120 in formation 108. In one possible implementation, desired zones of wellbore 102 can be subjected to the pressurized fracturing fluid through use of the mechanically actuated valves, while other areas of wellbore 102 can be hydraulically isolated from the fracturing fluid by isolation packers 128. For example, in one possible aspect, the mechanically actuated valves can be activated in turn (for example, from the bottom upwards) by a given diameter ball being dropped into the fracturing fluid and pumped via completion string 126 to a seat designed to receive the ball's particular diameter.

In one possible implementation, loggers 124 can be installed in a variety of locations in wellbore 102 in FIG. 2. For example, loggers 124 can be installed at various locations on completion string 126, such as on one or more isolation packers 128. Loggers 124 can also be deployed on a telemetry/power cable and/or within the annular space between completion string 126 and formation 108.

In one possible implementation, a battery-powered sensing/receiving system including loggers 124 can be permanently installed in and/or around wellbore 102, enabling live, real-time acquisition of data transmitted by smart proppant beads 122, and/or delayed transmission of such data to the surface when equipment such as a wellbore intervention tool is in use proximate to the loggers 124.

For example, in one possible implementation, loggers 124 can acquire data from smart proppant beads 122 in fractures 120, then wait for equipment, such as, for example, an intervention tool, to pass by. Loggers 124 can then transmit the data they have collected to the equipment, which can transmit and/or convey the data to the surface. Loggers 124 can transmit the data using any of a variety of transmitting technologies known in the art.

In one possible aspect, battery-powered loggers 124 can remain active until battery power is drawn down to a predetermined level (such as, for example, 10%) at which point the loggers 124 can switch to a standby mode to save battery power. The loggers 124 can then be triggered to transmit the data they have received when equipment configured to accept the data passes by. In one possible implementation, the trigger can be a signal sent from the equipment and received by the loggers 124.

### Example System(s) and/or Technique(s)

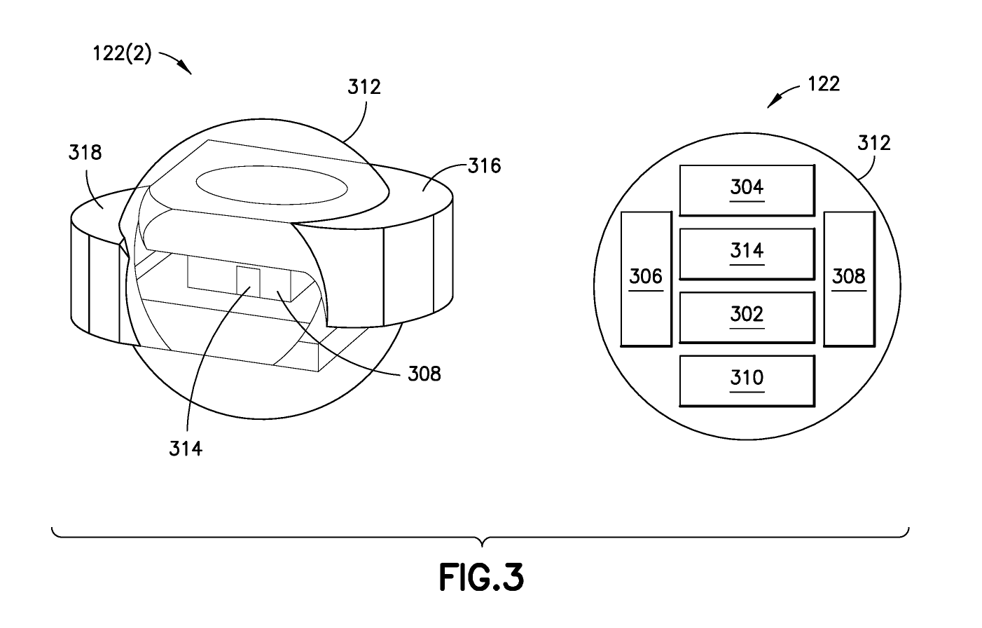

FIG. 3 illustrates example smart proppant beads 122 in accordance with embodiments of fracture monitoring. Smart proppant beads 122 can take any form known in the art including, for example, circular, oblong, cylindrical, etc., and can come in any sizes known in the art. For example, in one possible implementation, smart proppant beads 122 can have diameters ranging from 300 μmeters to 2 millimeters.

In one possible implementation, smart proppant beads 122 can be configured to detect data associated with one or more environmental stimuli in a surrounding environment (such as a fracture 120) and transmit this data back to a logger 124. Environmental stimuli can include any condition associated with the environment surrounding a smart proppant bead 122 including, for example, temperature, pH level, pressure, force, presence of various well fluids and materials, etc. In one possible aspect, a smart proppant beat 122 can directly transmit data to logger 124. In another possible aspect, a smart proppant bead 122 can transmit data to logger 124 through multiple relay connections, including through connections with other smart proppant beads 122, as will be discussed in more detail below.

In one possible embodiment, characterization of a transmitting smart proppant bead 122 and/or receipt of data it has measured may allow for inversion to help understand the nature and extent of a fracture 120 in which the smart proppant bead 122 finds itself, and potentially allow a fracture design loop to be closed. This can include for example, estimating qualities such as flow rate in the fracture based on experimental models.

In one possible embodiment, smart proppant bead 122 can include a power source 302, a sensor 304, a transmitter 306, and electronic functionality 308. Other implementations can also include a receiver 310.

In some instances, one or more of power source 302, sensor 304, transmitter 306, electronic functionality 308 and receiver 310 (when present) can be encapsulated in a pressure resistant and/or fluid sealed package 312. Package 312 can be made of any pressure resistant and/or fluid resistant material known in the art, including, for example, an inert polymer, such as PEEK. In one possible implementation, smart proppant bead 122 can have a finite design life. In such a case, package 312 can be made from materials enabling smart proppant bead 122 to reach its design life.

In some possible implementations, smart bead 122 can include one or more aerials 314, with a portion thereof extending outside of package 312. Aerial 314 can be made of any material known in the art, including, for example, carbon fiber, various metal alloys, etc., and can be coupled to one or more of power source 302, sensor 304, transmitter 306, electronic functionality 308, an receiver 310 (if present).

Power source 302 can include any power source known in the art, including, for example, a battery of any variety known in the art, a piezoelectric element, a receiver of transmitted energy (such as a radio frequency (RF) receiver), a galvanic cell, etc. In some instances, power source 302 can include several power sources, include those of different types. For instance power source 302 can include a piezoelectric element, a battery, and a galvanic cell.

Similarly, sensor 304 can include any sensing technology known in the art, such as, for example, a piezoelectric element, a galvanic cell, a uniaxial sensor that evidences a measurable shift in characteristics upon deformation, etc. In one possible implementation, sensor 304 can include several sensors, including sensors of different types. Moreover, in some possible embodiments, sensor 304 can also act as power source 302. For example, sensor 304 can include a piezoelectric element placed under stress (such as stress created by pressure from one or more sources, such as formation stress). This stress can cause the piezoelectric element to create an activation signal (such as, for example an electric charge) sufficient to power smart proppant bead 122. Moreover, the size of the charge as well as the individual characteristics of the piezoelectric element, can be used to determine a magnitude of the stress being placed on smart proppant bead 122.

In instances where multiple smart proppant beads 122 with piezoelectric sensors 304 are under stress, identification information associated with the smart proppant beads 122 such as serial numbers, tags, etc., can be transmitted to logger 124 allowing for identification of which smart proppant beads 122 in a proppant ramp are experiencing a change in stress, thereby potentially providing some indication of where in a fracture system stresses might be changing. In one possible implementation, identification information can also include data measured by sensor 304.

FIG. 3 illustrates an example smart proppant bead 122(2) utilizing a galvanic cell in the form of two electrodes 316, 318, which can be formed from any materials known in the art capable of forming an electrochemical couple. In such a way, electrodes 316, 318 can remain inactive while dry, but become activated on contact with, for example, fracturing fluid, to provide a temporary power source 302 for smart proppant bead 122(2). In one possible implementation, electrodes 316, 318 can comprise magnesium and silver-chloride. In one possible aspect, electrodes 316, 318 can be coated or otherwise incorporated into a protective frame, such as package 312, designed to hold electrodes 316, 318 physically separate from one another. In another example, the fracturing fluid can be tailored to provide enhanced electrolytic functionality for the electrode couple employed.

In one possible implementation, electrical connections between power source 302 formed by electrodes 316, 318 and other elements of smart proppant bead 122(2), such as electrical functionality 308, sensor 304, transmitter 306, and receiver 310 (if present) can be made using any technique known in the art. These techniques can include, for example, wire bonding and/or thermo-compression bonding between the various elements.

Alternately, or additionally, electrodes 316, 318 can be coupled by a carbon fiber. Moreover, if aerial 314 is employed, it may be used to form an anode of the galvanic cell, potentially simplifying a construction of smart proppant bead 122(2).

In one possible implementation, in addition to forming a power source 302 for smart proppant bead 122(2), electrodes 316, 318 may alternately, or additionally, comprise a sensor 304 for smart proppant bead 122(2).

For example, materials used to form electrodes 316, 318, can be chosen to create a voltage in a given environment (such as, for example, a given pH environment and/or in the presence of given materials). Stated another way for the sake of clarity, electrodes 316, 318 can be chosen to form an electrochemical couple and generate an electric charge in the presence of a predetermined environment, such as, for example, in the presence of a predetermined well fluid. Thus, when smart proppant bead 122(2) is deployed in fracture 120, once a charge is generated by electrodes 316, 318, it can be deduced that electrodes 316, 318 are in contact with the given pH environment and/or the given materials.

Additionally, in one possible implementation, portions of electrodes 316, 318 outside of package 312 may be coated with a variety of fluid resistant coatings designed to deteriorate in the presence of a given environment (such as, for example, a temperature environment, a pH environment and/or in the presence of given materials). Thus, if electrodes 316, 318 form a charge, it may be deduced that smart proppant bead 122(2) is in the presence of the given temperature environment, pH environment and/or materials capable of dissolving the coating on electrodes 316, 318. In one possible aspect, the terms “temperature environment” and “pH environment”, as used herein can be interpreted to mean “temperature range” and “pH range”, respectively.

Electronic functionality 308 can include any functionality known in the art capable of carrying out instructions, matching inputs to outputs, etc. Electronic functionality 308 can include one or more simple circuits, which themselves can be considered computing devices, etc. In one possible implementation, electronic functionality 308 can include an electronic chip comprising a semiconductor substrate, such as, for example, silicon, gallium arsenide, etc.

In one possible implementation, a charge generated by power source 302 can act as an activation signal, triggering electronic functionality 308 to direct transmitter 306 to transmit data. Alternately, in another possible implementation, once electronic functionality 308 receives an activation signal, such as, for example, via receiver 310, electronic functionality 308 can direct transmitter 306 to transmit data. In either case, transmitter 306 can include any type of transmitter(s) known in the art, and it can transmit any type of data known in the art, in any format known in the art (including for example, electromagnetic signals, etc.).

For example, in one possible implementation, transmitter 306 can transmit a variety of data including measurements as well as identification information indicating the types of smart proppant beads 122 and/or sensors 304 which collected the measurements. In one possible embodiment, identification information can also include the data collected by sensor 304.

For instance, in one possible embodiment, transmitter 306 can transmit a numerical value identifying a type of sensor 304 associated with a type of measured data being transmitted. Transmitter 306 can also transmit a digitally encoded representation of a numerical output of a sensor 304. In another possible embodiment, transmitter 306 can transmit an identification code associated with a particular type of smart proppant bead 122. Such an identifier can give a user an idea of any of a variety of characteristics associated with the smart proppant bead 122, including, for example, a size of the smart proppant bead 122, a shape of the smart proppant bead 122, what types of sensors 304 the smart proppant bead 122 may have, in what types of environments the smart proppant bead 122 may generate power, etc.

Identification information of this type may be useful, for example, when multiple designs of smart proppant beads 122 are present within a given volume of proppant in fracture 120. For example, if a galvanic cell of a particular design of smart proppant bead 122 is active in a certain pH range, then information identifying the design of the smart proppant bead 122 can be used to provide a binary indication of acidic or alkaline conditions proximate the smart proppant bead 122, which in turn can be used to infer aspects of fluid composition within the fracture 120.

In another possible implementation, transmitter 306 can transmit data at a particular frequency interpreted from a given output of sensor 304. For example, rather than constructing a digital sequence for the transmission of encoded numerical values, it may be more energy efficient to transmit data as a tone-burst, where a central frequency, or repetition frequency of the tone-burst is related to an output of a particular value from sensor 304.

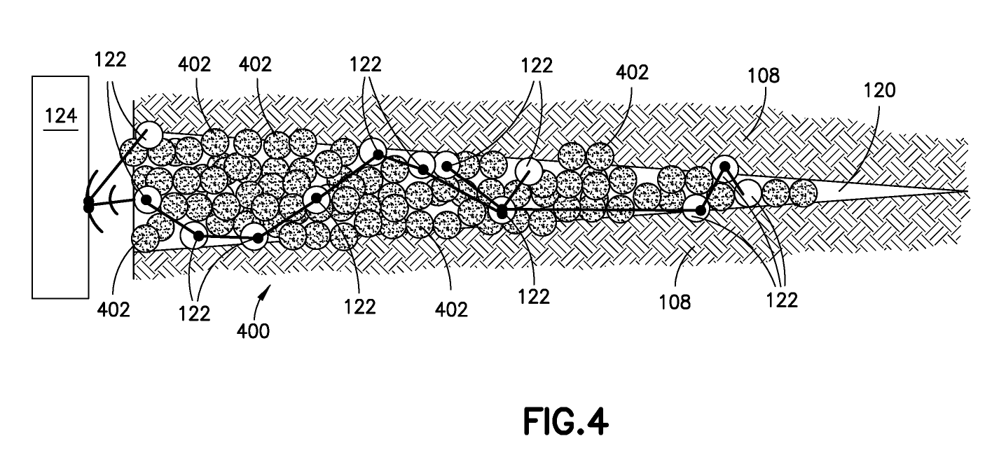

FIG. 4 illustrates an example proppant pack 400 in an example fracture 120 in accordance with implementations of fracture monitoring. Proppant pack 400 includes a plurality of smart proppant beads 122 mixed in with a plurality of regular proppant particles 402 (such as sand particles, ceramic particles, etc.) in fracture 120. In one possible implementation, proppant pack 400 can be placed into fracture 120 through various ramps.

The ratio of smart proppant beads 122 to regular proppant particles 402 in proppant pack 400 can be varied as desired. For example, in one possible implementation, 0.1%-10% of proppant pack 400 can comprise smart proppant beads 122.

A variety of different types and sizes of smart proppant beads 122 can be employed in proppant pack 400. For example, in one possible implementation, smart proppant beads 122 with small diameters can be used in early ramps giving them an opportunity to travel far into fracture 120. In one possible aspect, smart proppant beads 122 with larger diameters can be used in successive ramps. In one possible embodiment, if data is received from a small smart proppant bead 122, it may be inferred that the data is coming from deeper inside fracture 120 than data received from a larger size smart proppant bead 122.

In another possible embodiment, a variety of different types of smart proppant beads 122 capable of turning on and/or measuring conditions in a variety of different environments can be used in proppant pack 400. For example, proppant pack 400 may include a first type of smart proppant bead 122 that turns on in an acidic environment as well as a second type of smart proppant bead 122 that turns on when a given fluid is present. Thus, if logger 124 receives a signal from the first type of smart proppant beads 122, it can be inferred that an acidic environment exists in fracture 120. Similarly, if logger 124 receives a signal from the second type of smart proppant beads 122, it can be inferred that the given fluid is present in fracture 120.

In this manner as many different characteristics as desired can be measured for in fracture 120 by including in proppant pack 400 corresponding smart proppant beads 122 configured to measure and/or turn on in the presence of such characteristics, and/or when activated with a specific fluid pumped from surface.

Transmission of data from smart proppant beads 122 to logger 124 can happen in any manner known in the art. For example, in one possible implementation, transmitter 306 can transmit data (including identification data and data measured using from sensor 304) by broadcasting the data to logger 124 using any type of electromagnetic energy known in the art, including, for example, ultra-low power radio frequency (RF) energy.

In another possible implementation, a direct percolative transmission connection may be formed by electrically coupling a smart proppant bead 122 to logger 124. In one possible aspect, this can be accomplished by aerial 314 of smart proppant bead 122 physically touching logger 124. In another possible implementation, a direct percolative transmission connection can be created between smart proppant bead 122 and logger 124 through the use of conductive elements, such as conductive well fluids and/or conductive fibers included within proppant pack 400. Conductive fibers can be made of any conductive materials known in the art, including, for example, carbon fibers, and can be in any diameters and/or lengths desired. For example, in one possible embodiment, carbon fibers having a diameter of 10 μm or smaller can be employed. The concentration of conductive fibers in proppant pack 400 can be set in any manner desired, and conductive fibers can be introduced into proppant pack 400 in any way known in the art.

In one possible embodiment, direct percolative transmission connections may be useful in initial characterization efforts. For example, a single job can be pumped in a given field using smart proppant beads 122 and potentially also conductive fibers as described above. The information received from these smart proppant beads 122 via direct percolative transmission connections may then be used to tailor subsequent hydraulic fracturing processes for other fractures 120 in the field, including hydraulic fracturing processes not employing smart proppant beads 122, and/or hydraulic fracturing processes using smart proppant beads 122 configured for other types of data transmission outside of direct percolative transmission connections.

In yet another possible implementation, a semi-direct percolative connection can be created between smart proppant bead 122 and logger 124 through the use of conductive fibers and other smart proppant beads 122. For example, an aerial 314, or a conductive fiber in contact with aerial 314, of a first smart proppant bead 122 (aka an initial smart proppant bead 122) can contact a component of a second smart proppant bead 122 capable of receiving data (such as an electrode 316, 318, aerial 314, receiver 310, etc.) and directly transmit data to the second smart proppant bead 122. The second smart proppant bead 122 can then retransmit the data from the first smart proppant bead 122 to a third smart proppant bead 122 using a similar percolative mechanism. This process can continue through more smart proppant beads 122 until the data from the first smart proppant bead is finally received by logger 124.

In yet another possible implementation, a semi-direct percolating broadcast connection can be created between smart proppant bead 122 and logger 124 using a plurality of smart proppant beads 122. For example, a first smart proppant bead 122 (aka an initial smart proppant bead 122) can transmit data by broadcasting it from its transmitter 306 to one or more second smart proppant beads 122. The one or more second smart proppant beads 122 can then rebroadcast the data from the first smart proppant bead 122 to one or more third smart proppant beads 122. This process of rebroadcasting can continue until the data from the first smart proppant bead 122 is received by logger 124.

In yet another possible implementation any of the above described transmission methods can be employed in any combination. For example, a first smart proppant bead 122 (aka an initial smart proppant bead 122) may transmit data to one or more second smart proppant beads 122 directly via aerial 314 and/or one or more conductive fibers in contact with the second smart proppant beads 122. Alternately, or additionally, first smart proppant bead 122 may transmit data by broadcasting it to one or more second smart proppant beads 122 using electromagnetic energy. The one or more second smart proppant beads 122, may then retransmit the data from the first smart proppant bead 122 to one or more third smart proppant beads 122 using any of the techniques described herein (for example, through conductive coupling, through broadcasting, etc.). This can continue using successive smart proppant beads 122, until the data from the first smart proppant bead 124 reaches logger 124.

The data from the first smart proppant bead 122 can include any data known in the art, including identification data associated with the first smart proppant bead 122, and data measured by sensor 304 of the first smart proppant bead 122. Successive smart proppant beads 122 may then add to the data by including information such as signal strength of the signal in which the data from the first smart proppant bead 122 was received. Signal strength from successive rebroadcasting smart proppant beads 122 can also be included in the rebroadcast data received by logger 124. In one possible embodiment, the signal strengths of the original broadcast from the first smart proppant bead 122 and the successive rebroadcaster smart proppant beads 122 may be useful in estimating a distance the data has travelled from first smart proppant bead 122 to logger 124.

In another possible implementation, successive smart proppant beads 122 involved in rebroadcasting and/or retransmitting data may add a transmission indicator indicating how many times the data from the first smart proppant bead 122 has been rebroadcast and/or retransmitted before reaching logger 124. In one possible implementation, such an indicator may be useful in estimating how far the data from the first smart proppant bead 122 has travelled to get to logger 124.

Smart proppant beads 122 can become relays (rebroadcasters and/or retransmitters of data from other smart proppant beads 122) in a variety of ways. For example, in one possible implementation, if logger 124 detects a signal from a smart proppant bead 122 that is above a certain power threshold, the smart proppant bead 122 can be deemed too close to wellbore 102 to provide adequately representative data, and can be directed to function instead as a relay. In one possible aspect, if the signal power is above a second even higher threshold, the smart proppant bead 122 may be directed to become a radio relay and retransmit data directly to logger 124. Loggers 124 can communicate with smart proppant beads 122 using any communication technologies known in the art.

Such thresholds can be preset, and can be of any value desired. In one possible embodiment, such thresholds can vary for different formation types, well environments, etc.

In another possible implementation, a smart proppant bead 122 can detect a preset number of other active smart proppant beads 122 in its proximity, and choose to relay the weakest signal received. In one possible implementation, the signals received from the proximate smart proppant beads 122 can be used to estimate various qualities of fracture 120, including, for example, a width, a depth, etc., of fracture 120.

In yet another possible implementation, a first smart proppant bead 122 can receive data from a sensor 304 on a second smart proppant bead 122 with a greater magnitude than measured by the sensor 304 on the first smart proppant bead 122. In such an instance, the data from the second smart proppant bead 122 can be deemed more relevant, and the first smart proppant bead 122 can become a relay and retransmit and/or rebroadcast the data from the second smart proppant bead 122.

In still another possible implementation, when a smart proppant bead 122 detects electrical contact with one or more other smart proppant beads 122, a switch may be triggered directing the smart proppant bead 122 to become a relay through any contact transmission mechanism known in the art with the one or more other smart proppant beads 122.

In still another possible implementation, a smart proppant bead 122 acting as a relay may reconfigure itself to cease being a relay and instead transmit information from its own sensor 304. This can happen in a variety of circumstances, such as, for example, when a signal being relayed from another smart proppant bead 122 is lost, or drops below a given threshold. In this way, smart proppant beads 122 can flip between automatically configuring themselves as relays and reconfiguring themselves as transmitters as many times as desired.

In such manners as those described above, either singly or in any combination, a network of smart proppant beads 122 in fracture 120 can dynamically reconfigure itself to present relevant and/or desirable data from potentially deep within a fracture 120 using a number of relays across smart proppant beads 122.

Logger 124 can be active and/or passive. For example, in one possible implementation logger 124 can passively await signals from smart proppant beads 122 in fracture 120. In another possible implementation, logger 124 can be active, emitting a signal to trigger smart proppant beads 122 in fracture 120 to start transmitting data. This trigger signal can take any form in the art, including, for example, a radio-frequency, and/or a low frequency intended to deliver a trigger signal deep into formation 108 through, for instance, impressed currents. In one possible implementation, the trigger signal can act as an activation signal, triggering electronic functionality 308 to direct transmitter 306 to transmit any of a variety of data associated with smart proppant bead 122 and the data it may have measured.

In one possible implementation, use of smart proppant beads 122 having a variety of sizes, types of sensors 304, activation thresholds, etc., as described herein can be useful in estimating a wide range of characteristics, such as, for example, length and/or azimuth of fracture 120, fluid types trapped in pore space in formation 108, and flow rates of various fluids and/or gasses trapped in impermeable materials in formation 108.

### Example Methods

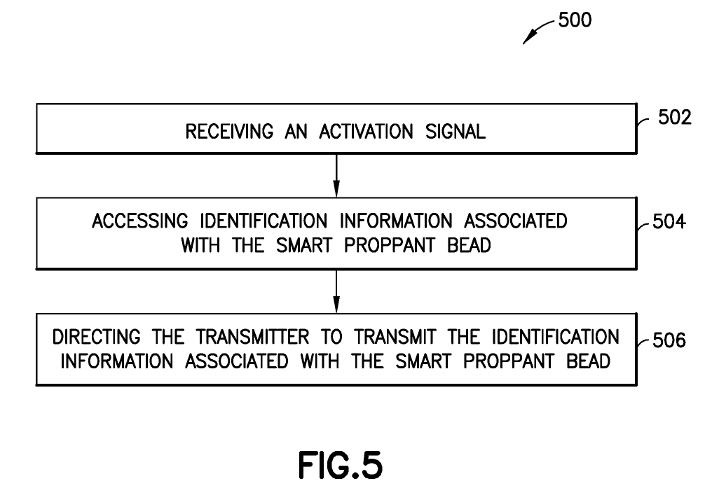

FIG. 5 illustrates an example method for implementing aspects of fracture monitoring. The method is illustrated as a collection of blocks and other elements in a logical flow graph representing a sequence of operations that can be implemented in hardware, software, firmware, various logic or any combination thereof. The order in which the method is described is not intended to be construed as a limitation, and any number of the described method blocks can be combined in any order to implement the method, or alternate methods. Additionally, individual blocks and/or elements may be deleted from the method without departing from the spirit and scope of the subject matter described therein. In the context of software, the blocks and other elements can represent computer instructions that, when executed by one or more processors, perform the recited operations. Moreover, for discussion purposes, and not purposes of limitation, selected aspects of the methods may be described with reference to elements shown in FIGS. 1-4 and FIG. 6.

FIG. 5 illustrates an example method 500 associated with embodiments of fracture monitoring. At block 502 an activation signal is received at a smart proppant bead, such as smart proppant bead 122. In one possible implementation, this activation signal can be received from a remote sensor, such as logger 124, by a receiver such as receiver 301, and/or the activation signal can come from a power source, such as power source 302, and/or a sensor, such as sensor 304.

At block 504, identification information associated with the smart proppant bead is accessed. For example, in one possible implementation, the identification information can include any data measured by the smart proppant bead along with any information regarding the smart proppant bead itself (such as, for example, the size of the smart proppant bead, the shape of the smart proppant bead, the type of sensor(s) on the smart proppant bead, what environment the smart proppant bead many be tuned to turn on in, etc.).

At block 506, the transmitter is directed to transmit the identification information associated with the smart proppant bead. In one possible implementation, a transmitter, such as transmitter 306, is directed to transmit the identification information using any of the methods described herein, including any combinations thereof. The identification information can be transmitted to another smart proppant bead and/or the remote sensor.

### Example Computing Device(s)

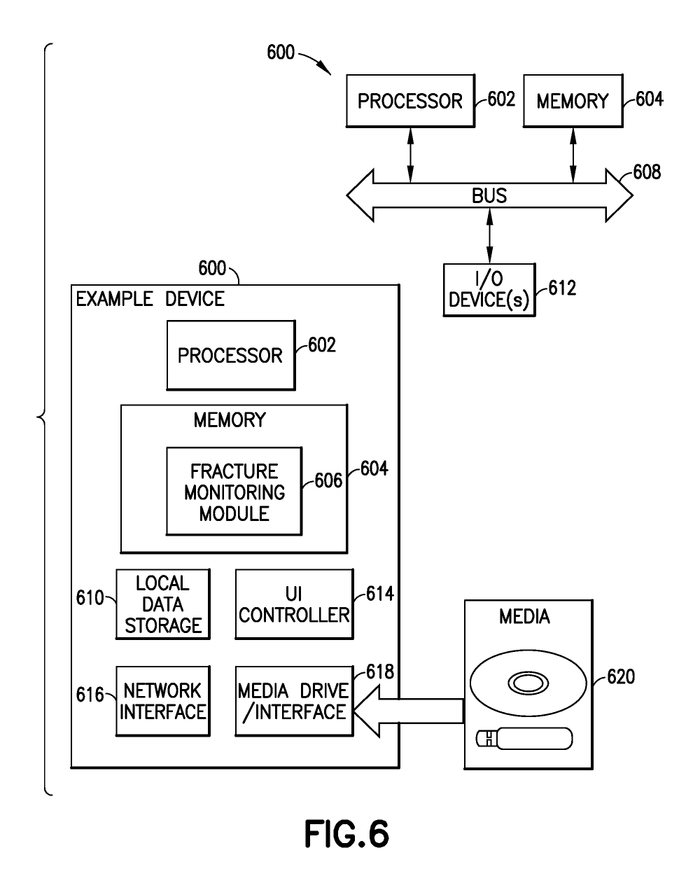

FIG. 6 illustrates an example device 600, with a processor 602 and memory 604 for hosting a fracture monitoring module 606 configured to implement various embodiments of fracture monitoring as discussed in this disclosure. In one possible implementation, electronic functionality 308 may include all of portions of example device 600. Moreover, logger 124 may include all or portions of example device 600. Similarly, equipment configured to receive data from logger 124 and use the data to monitor fracture 120 in formation 108, and perform other calculations and estimations regarding hydraulic fracturing and/or hydrocarbon production from formation 108, may comprise example device 600.

Memory 604 can also host one or more databases and can include one or more forms of volatile data storage media such as random access memory (RAM), and/or one or more forms of nonvolatile storage media (such as read-only memory (ROM), flash memory, and so forth). In one possible implementation, memory 604 can store a variety of data discussed herein, including, for example, identification information, data measured by sensor(s) 304, etc.

Device 600 is one example of a computing device or programmable device, and is not intended to suggest any limitation as to scope of use or functionality of device 600 and/or its possible architectures. For example, device 600 can comprise one or more computing devices, programmable logic controllers (PLCs), etc.

Further, device 600 should not be interpreted as having any dependency relating to one or a combination of components illustrated in device 600. For example, device 600 may include one or more of a computer, such as a laptop computer, a desktop computer, a mainframe computer, a simple on chip computing device, etc., or any combination or accumulation thereof.

Device 600 can also include a bus 608 configured to allow various components and devices, such as processors 602, memory 604, and local data storage 610, among other components, to communicate with each other.

Bus 608 can include one or more of any of several types of bus structures, including a memory bus or memory controller, a peripheral bus, an accelerated graphics port, and a processor or local bus using any of a variety of bus architectures. Bus 608 can also include wired and/or wireless buses.

Local data storage 610 can include fixed media (e.g., RAM, ROM, a fixed hard drive, etc.) as well as removable media (e.g., a flash memory drive, a removable hard drive, optical disks, magnetic disks, and so forth).

One or more input/output (I/O) device(s) 612 (such as sensor(s) 304, and transmitter(s) 306, for example) may also communicate via a user interface (UI) controller 614, which may connect with I/O device(s) 612 either directly or through bus 608.

In one possible implementation, a network interface 616 may communicate outside of device 600 via a connected network, and in some implementations may communicate with hardware, such as smart proppant bead(s), one or more loggers 124, etc.

In one possible embodiment, sensor(s) 124 and/or other equipment may communicate with device 600 as input/output device(s) 612 via bus 608, for example.

A media drive/interface 618 can accept removable tangible media 620, such as flash drives, optical disks, removable hard drives, software products, etc. In one possible implementation, logic, computing instructions, and/or software programs comprising elements of fracture monitoring module 606 may reside on removable media 620 readable by media drive/interface 618.

In one possible embodiment, input/output device(s) 612 can allow a user to enter commands and information to device 600, and also allow information to be presented to the user and/or other components or devices. Examples of input device(s) 612 include, for example, sensors, a keyboard, a cursor control device (e.g., a mouse), a microphone, a scanner, and any other input devices known in the art. Examples of output devices include a display device (e.g., a monitor or projector), speakers, a printer, a network card, and so on.

Various processes of fracture monitoring module 606 may be described herein in the general context of software or program modules, or the techniques and modules may be implemented in pure computing hardware. Software generally includes routines, programs, objects, components, data structures, and so forth that perform particular tasks or implement particular abstract data types. An implementation of these modules and techniques may be stored on or transmitted across some form of tangible computer-readable media. Computer-readable media can be any available data storage medium or media that is tangible and can be accessed by a computing device. Computer readable media may thus comprise computer storage media. “Computer storage media” designates tangible media, and includes volatile and non-volatile, removable and non-removable tangible media implemented for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible medium which can be used to store the desired information, and which can be accessed by a computer.

Although a few example embodiments have been described in detail above, those skilled in the art will readily appreciate that many modifications are possible in the example embodiments without materially departing from this disclosure. Accordingly, such modifications are intended to be included within the scope of this disclosure as defined in the following claims. Moreover, embodiments may be performed in the absence of any component not explicitly described herein.

In the claims, means-plus-function clauses are intended to cover the structures described herein as performing the recited function and not just structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words ‘means for’ together with an associated function.

1. A smart proppant bead comprising:
electronic functionality;
a transmitter;
a sensor; and
a power source.

2. The smart proppant bead of claim 1, wherein the transmitter is configured to transmit identification information associated with the smart proppant bead including one or more of:
a numerical value associated with the sensor;
a digitally encoded representation of an output of the sensor;
an identification code associated with the smart proppant bead;
a frequency interpreted from an output of the sensor; and
data collected using the sensor.

3. The smart proppant bead of claim 1, wherein the transmitter is configured to transmit information as a tone-burst.

4. The smart proppant bead of claim 1, wherein the power source comprises a piezoelectric element.

5. The smart proppant bead of claim 4, wherein the piezoelectric element also functions as the sensor.

6. The smart proppant bead of claim 1, wherein the power source comprises a receiver of radio frequency energy.

7. The smart proppant bead of claim 1, wherein the power source comprises a galvanic cell.

8. The smart proppant bead of claim 7, wherein the galvanic cell also functions as the sensor.

9. The smart proppant bead of claim 7, wherein the galvanic cell comprises two electrodes configured to form an electrochemical couple in the presence of a predetermined environment.

10. The smart proppant bead of claim 9, wherein one of the two electrodes comprises an aerial.

11. The smart proppant bead of claim 1, wherein the sensor comprises one or more of:
a uniaxial sensor;
a piezoelectric element; and
a galvanic cell.

12. A smart proppant bead comprising:
electronic functionality;
a transmitter;
a receiver;
a sensor; and
a power source.

13. The smart proppant bead of claim 12, wherein the sensor comprises:
a piezoelectric element configured to generate an activation signal when subjected to a preset level of stress; and further wherein the electronic functionality is configured to instruct the transmitter to transmit identification information associated with the smart proppant bead once the electronic functionality detects the activation signal.

14. The smart proppant bead of claim 12, wherein the sensor comprises:
two electrodes configured to form an electrochemical couple and generate an electrical charge in the presence of a predetermined well fluid; and further wherein the electronic functionality is configured to instruct the transmitter to transmit identification information associated with the smart proppant bead once the electronic functionality detects the electrical charge.

15. The smart proppant bead of claim 12, wherein the power source comprises one or more of:
a piezoelectric element;
a galvanic cell; and
a receiver of radio frequency energy.

16. The smart proppant bead of claim 13, wherein the electronic functionality is configured to facilitate receiving and retransmitting one or more of:
identification information associated with an initial smart proppant bead; and
a transmission indicator indicating a number of smart proppant beads which have rebroadcast the identification information associated with the initial smart proppant bead.

17. The smart proppant bead of claim 12, wherein the smart proppant bead is configured to automatically reconfigure itself to flip between being a relay and a transmitter of information detected at the sensor.

18. A smart proppant bead including:
a receiver;
a transmitter;
a power source;
a processor; and
a computer-readable tangible medium with instructions stored thereon that, when executed, direct the processor to perform acts comprising:
receiving an activation signal;
accessing identification information associated with the smart proppant bead; and
directing the transmitter to transmit the identification information associated with the smart proppant bead.

19. The smart proppant bead of claim 18, wherein the computer-readable tangible medium further includes instructions to direct the processor to perform acts comprising:
receiving the activation signal from the receiver.

20. The smart proppant bead of claim 18, wherein the computer-readable tangible medium further includes instructions to direct the processor to perform acts comprising:
receiving the activation signal from the power source.
